(19) United States
(12) Patent Application Publication
(10) Pub. No.: US 2026/0070238 A1
(43) Pub. Date: Mar. 12, 2026

(54) CONVEYANCE DEVICE

(71) Applicant: FUTABA INDUSTRIAL CO., LTD., Okazaki-shi (JP)

(72) Inventor: Tatsuya Koyama, Okazaki-shi (JP)

(21) Appl. No.: 19/306,150

(22) Filed: Aug. 21, 2025

(30) Foreign Application Priority Data
Sep. 12, 2024 (JP) 2024-158372

(51) Int. Cl. B25J 15/10

(52) U.S. Cl. CPC B25J 15/103

(57) ABSTRACT

Provided is a conveyance device configured to lift and move an object. The conveyance device includes a base and at least three rod portions. Each of the at least three rod portions is rotatable about a rotation axis extending along an up-down direction and has a projection. The projection protrudes from a first side surface in a direction away from the rotation axis and does not protrude from a second side surface. A distance from the rotation axis to a most protruding portion of the projection is greater than a distance from the rotation axis to the second side surface.

### CROSS-REFERENCE TO RELATED APPLICATIONS

The present application claims the benefit of Japanese Patent Application No. 2024-160268 filed on September 17, 2024 with the Japan Patent Office, the entire disclosure of which is incorporated herein by reference.

### BACKGROUND

The present disclosure relates to a conveyance device.

Japanese Patent Publication No. 5766767 (hereinafter, referred to as Document 1) describes a robot hand for holding and conveying a cylindrical object. The robot hand has three fingers configured to radially move so that the three fingers are positioned on a concentric circle. Two rollers are provided at a bottom end of each finger and hold an end of the object therebetween.

### SUMMARY

A conveyance device, such as a robot hand, for lifting and moving an object performs a motion of lifting the object and a motion of lowering the lifted object at its destination. The robot hand in Document 1, when performing each motion, needs to be controlled to horizontally move the three fingers closer to the object or farther away from the object.

One aspect of the present disclosure provides a technique in which a motion of lifting an object and a motion of lowering the lifted object at its destination can be performed with a simple configuration.

One embodiment of the present disclosure provides a conveyance device for lifting and moving an object. The conveyance device comprises a base and at least three rod portions. The base holds the at least three rod portions at a specified horizontal width and is attachable to a moving device configured to move the conveyance device from a location where the object is to a location where the object is to be conveyed. Each of the at least three rod portions is attached to the base and extends downward of the base. Moreover, each of the at least three rod portions is rotatable about a rotation axis extending along an up-down direction and has a projection. The projection protrudes from a portion of a side surface of each of the at least three rod portions and is designed to come into contact with a bottom surface of the object. Here, it is assumed that the side surface of each of the least three rod portions is divided by a virtual plane. The virtual plane is a vertically extending plane and divides the side surface of each of the at least three rod portions into a first side surface with the projection and a second side surface without the projection. At this point in time, the projection protrudes from the first side surface in a direction away from the rotation axis and does not protrude from the second side surface. A distance from the rotation axis to a most protruding portion of the projection, in a cross section of each of the at least three rod portions orthogonal to the rotation axis at a position where the projection is formed, is greater than a distance from the rotation axis to the second side surface.

If the rod portion is not rotatable, then it is necessary to translate the rod portion at least by a protruding amount of the projection when a motion of lifting the object and a motion of lowering the lifted object at its destination are performed.

However, according to the above-described configuration, the object can be lifted by the projection while the projection is facing the object. On the other hand, the object can be lowered while the projection is facing away from the object. These two states can be switched by rotating the rod portion. Since it is possible to dispense with a mechanism for translating the rod portion for performing each motion, the motion of lifting an object and the motion of lowering the lifted object at its destination can be performed with a simple configuration.

In one embodiment of the present disclosure, the conveyance device may further comprise a holding member. The holding member may be a rod-shaped member extending downward of the base. In addition, the holding member may include a moving mechanism configured to move to a first position and a second position. The first position is located at a height position where a bottom end of the holding member comes into contact with a top surface of the object. The second position is located higher than the top surface of the object.

The above configuration allows the object to be held between the projection and the holding member when the bottom end of the holding member is located at the first position. Thus, it is possible to convey the object in a stable manner.

In one embodiment of the present disclosure, each of the at least three rod portions includes a first rod portion and a second rod portion. The first rod portion is coupled to the base. The second rod portion extends downward from a bottom end of the first rod portion. Also, the second rod portion may have a projection. When the first rod portion and the second rod portion are divided into two by the virtual plane, a maximum distance from the rotation axis to the first side surface, in a cross section of the second rod portion orthogonal to the rotation axis at a position where the projection is formed, may be greater than a distance from the rotation axis to the second side surface. The second side surface in the second rod portion may be formed on an inner side compared to the second side surface in the first rod portion. The inner side is a side from a side surface of the first rod portion toward the rotation axis.

With the configuration as above, a side where the projection does not protrude is recessed on the inner side. Thus, when the projection is facing away from the object, a clearance is formed between the object and the second side surface in the second rod portion. Accordingly, the object is less likely to hit the second side surface of the second rod portion when the object falls, making it easier to lower the object without damaging the object.

In one embodiment of the present disclosure, a curvature radius of the first side surface in the second rod portion and a curvature radius of the second side surface in the second rod portion may be the same. Being the same includes being approximately the same.

With the configuration as above, since the second rod portion does not have corners and protrusions, the rod portion is less likely to hit the object when it rotates. Thus, the rod portion is less likely to damage the object while rotating.

In one embodiment of the present disclosure, at least one rod portion of the at least three rod portions may include a telescoping mechanism configured to switch a length of the at least one rod portion between a first length and a second length. The second length is longer than the first length.

The above configuration allows a height position of the projection to be varied for each rod portion. Thus, even with an object having a bottom surface with different height positions, the object can be placed on the projection by adjusting the length of the rod portion.

In one embodiment of the present disclosure, at least one rod portion of the at least three rod portions may have an upper rod portion and a lower rod portion. The upper rod portion is coupled to the base. The lower rod portion extends downward from a bottom end of the upper rod portion. Also, the lower rod portion may have a projection. The at least one rod portion may have a replacement mechanism configured to replace the lower rod portion with another lower rod portion.

The above configuration allows the height position of the projection to be varied, for example, by replacing the lower rod portion with another lower rod portion having a different length. Thus, even with an object having a bottom surface with different height positions, the object can be placed on the projection by adjusting the length of the lower rod portion.

In one embodiment of the present disclosure, the at least three rod portions may be horizontally movable. A distance that each of the rod portions horizontally moves from a specified position may be set for each rod portion.

The above configuration allows the horizontal position of each rod portion to be set in accordance with the shape of the object. Since objects having various shapes are applicable, versatility of the conveyance device can be increased.

### BRIEF DESCRIPTION OF THE DRAWINGS

An example embodiment of the present disclosure will be described hereinafter with reference to the accompanying drawings, in which:

FIG. 1 is a schematic perspective view of a conveyance device as seen from diagonally above;

FIG. 2 a schematic perspective view of the conveyance device as seen from diagonally below;

FIG. 3 is a schematic plan view of the conveyance device;

FIG. 4 is a schematic front view of the conveyance device;

FIG. 5 is a schematic right side view of the conveyance device;

FIG. 6 is a schematic perspective view of a rod portion and a holding member;

FIG. 7A is a schematic view of the rod portion for explaining a shape of the rod portion;

FIG. 7B is a schematic bottom view of the rod portion;

FIG. 8A is an explanatory view showing the rod portion before holding an object;

FIG. 8B is an explanatory view showing the rod portion holding the object;

FIG. 8C is an explanatory view showing the rod portion lowering the object;

FIG. 9 is a schematic view of the conveyance device when a second rod portion is replaced;

FIG. 10 is an explanatory view showing how the conveyance device is used in Variation 1;

FIG. 11 is an explanatory view showing how the conveyance device is used in Variation 2; and

FIG. 12 is an explanatory view showing how the conveyance device is used in Variation 3.

### DETAILED DESCRIPTION OF EXEMPLARY EMBODIMENTS

### [1. Embodiment]

### [1-1. Overall Configuration]

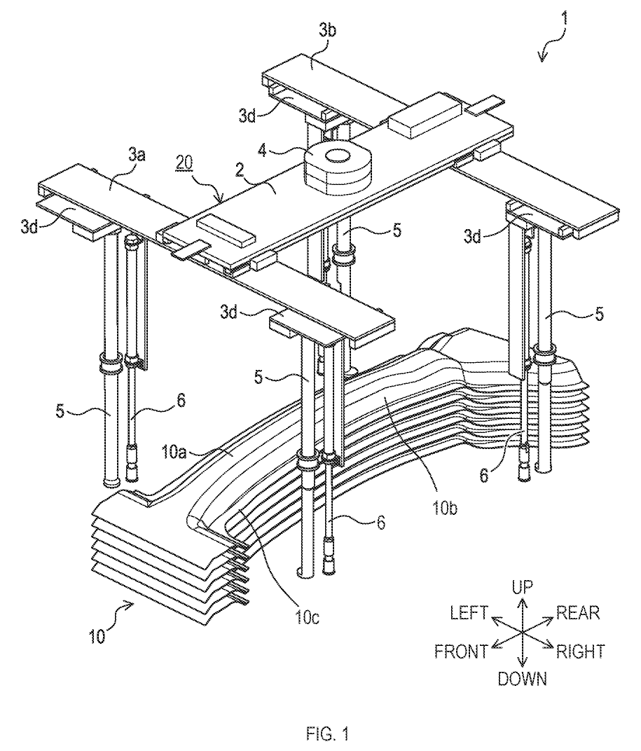

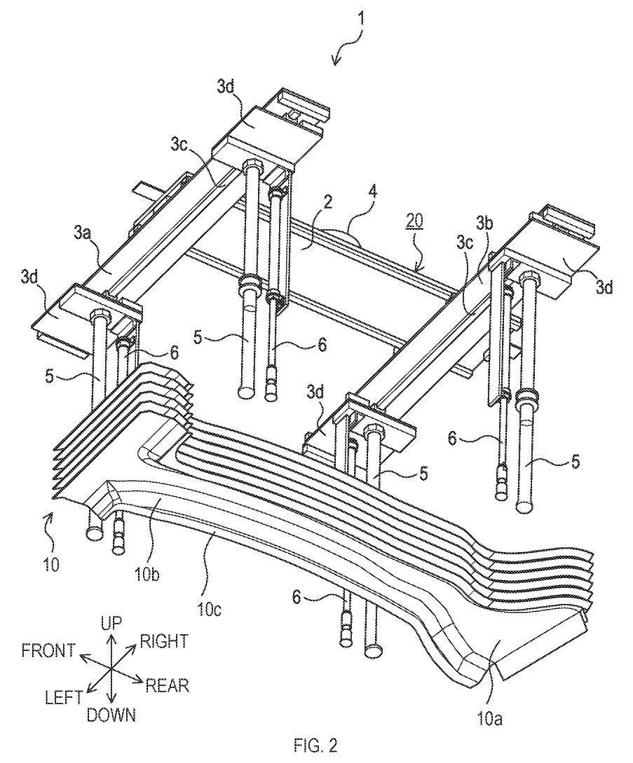

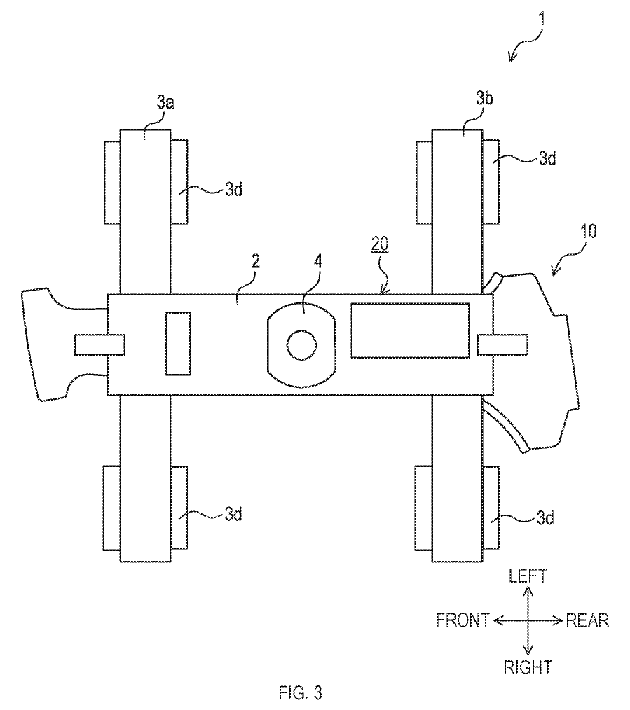

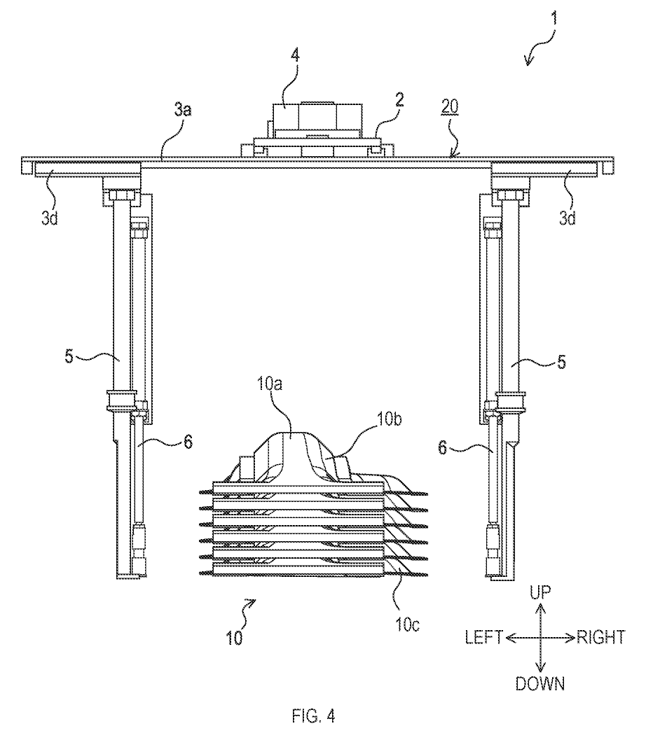

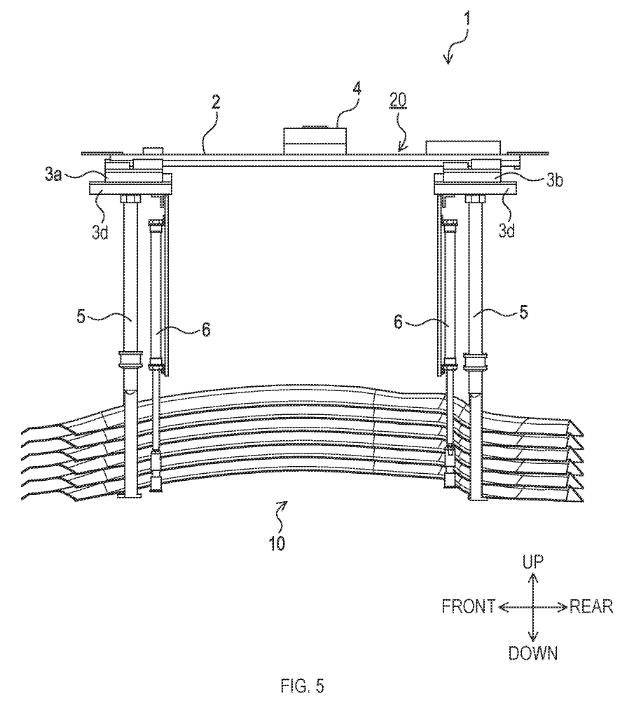

A conveyance device 1 shown in FIGS. 1 to 5 is a device for lifting and moving an object 10. The object 10 is, for example, a press-formed product. The object 10 is used as a center-pillar mounted on a vehicle, as an example. Hereinafter, a longitudinal direction of a first plate portion 2 to be described later is referred to as “front-rear direction”. A longitudinal direction of a second plate portion 3a and a third plate portion 3b to be described later is referred to as “right-left direction”. A longitudinal direction of a rod portion 5 to be described later is referred to as “up-down direction”. These directions are defined for the sake of explanation and do not limit how the conveyance device 1 is used.

The object 10 comprises a top plate portion 10a, a vertical wall portion 10b, and a flange portion 10c. The top plate portion 10a is a plate portion extending flat. The vertical wall portion 10b is a plate portion extending approximately downward from left and right ends of the top plate portion 10a. The flange portion 10c is a plate portion extending in a direction intersecting the vertical wall portion 10b from an end of the vertical wall portion 10b opposite to a portion where the vertical wall portion 10b and the top plate portion 10a are coupled. The flange portion 10c extends in a direction opposite to a direction in which the top plate portion 10a extends with respect to the vertical wall portion 10b. In the present embodiment, two or more objects 10 are stacked in the up-down direction.

The conveyance device 1 comprises a base 20, four rod portions 5, and four holding members 6.

The base 20 holds the four rod portions 5 at a specified horizontal width. In the present embodiment, the base 20 is a horizontally extending plate-shaped member. The base 20 includes a first plate portion 2, a second plate portion 3a, and a third plate portion 3b. The first plate portion 2 is a rectangular member having a longer length in the front-rear direction than in the right-left direction. An attachment part 4 is provided on a top surface of the first plate portion 2. The attachment part 4 is a coupling mechanism for coupling a not shown robotic arm and the base 20. The base 20 is not limited to a plate shape. For example, the base 20 may be formed in combination with a horizontally extending rod-shaped member.

The second plate portion 3a and the third plate portion 3b are rectangular plate-shaped members whose length in the right-left direction is longer than its length in the front-rear direction. The second plate portion 3a and the third plate portion 3b are provided on a bottom surface of the first plate portion 2. The second plate portion 3a and the third plate portion 3b are arranged so that longitudinal directions of the second plate portion 3a and the third plate portion 3b are approximately orthogonal a longitudinal direction of the first plate portion 2. The second plate portion 3a is provided at a front end of the first plate portion 2. The third plate portion 3b is provided at a rear end of the first plate portion 2.

A guide rail 3c is provided on a bottom surface of the second plate portion 3a. The guide rail 3c extends in a longitudinal direction of the second plate portion 3a. Two sliders 3d, which are slidable on the guide rail 3c, are provided on the bottom surface of the second plate portion 3a. The sliders 3d are approximately rectangular plate-shaped members in plan view. A distance that each of the two sliders 3d horizontally moves from a specified position can be set individually. For example, each slider 3d is configured to be slidable by using an electric cylinder.

Another guide rail 3c is provided on a bottom surface of the third plate portion 3b. The guide rail 3c extends in a longitudinal direction of the third plate portion 3b. Another two sliders 3d, which are slidable on the guide rail 3c, are provided on the bottom surface of third plate portion 3b. In the third plate portion 3b as well, a distance that each of the two sliders 3d horizontally moves from a specified position can be set individually.

The four rod portions 5 extend in the up-down direction. The four rod portions 5 are attached to the base 20 and extend downward of the base 20. More specifically, the four rod portions 5 are attached to the four sliders 3d one by one. That is, each rod portion 5 is horizontally movable in conjunction with the corresponding slider 3d. In other words, the four rod portions 5 are horizontally movable via the four sliders 3d. In the present embodiment, each rod portion 5 is movable in the right-left direction. A shape of the rod portion 5 will be later described in detail.

The four holding members 6 are rod-shaped members extending in the up-down direction. The holding members 6 are attached to the base 20 and extend downward of the base 20. More specifically, the four holding members 6 are attached to the sliders 3d one by one. That is, each holding member 6 is horizontally movable in conjunction with the corresponding slider 3d. In the present embodiment, each holding member 6 is movable in the right-left direction. The four holding members 6 are arranged in an area surrounded by the four rod portions 5 in plan view.

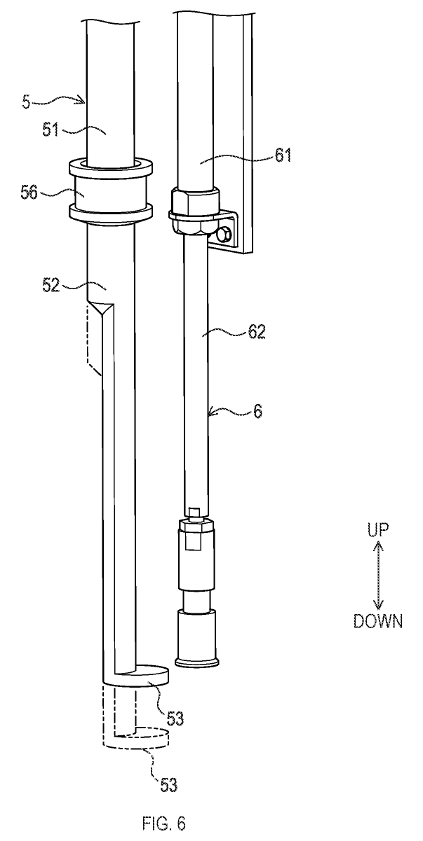

Each holding member 6 has a moving mechanism for moving a bottom end of the holding member 6 to a first position that is a height position where the bottom end of the holding member 6 comes into contact with a top surface of the object 10 and a second position higher than the top surface of the object 10. As an example, the moving mechanism is a pneumatic cylinder configured to move the bottom end of the holding member 6 up and down by compressed air. More specifically, as shown in FIG. 6, the moving mechanism includes a cylinder 61 and a piston rod 62. The moving mechanism adjusts a length of the piston rod 62 protruding from the cylinder 61 by moving the piston rod 62 up and down within an internal space of the cylinder 61.

### [1-2. Rod portion]

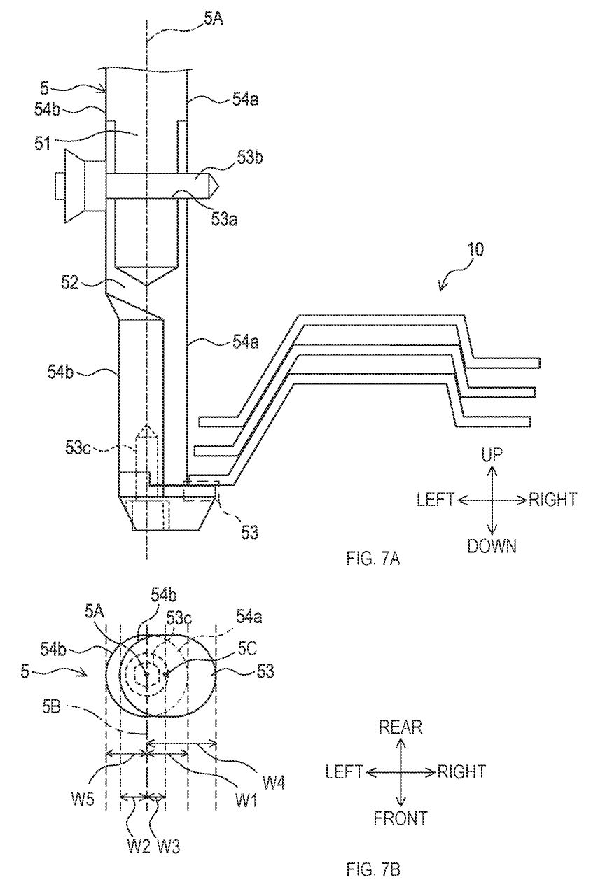

The four rod portions 5 have the same configuration. Thus, one rod portion 5 will be described hereinafter. As shown in FIGS. 7A and 7B, the rod portion 5 has a first rod portion 51 and a second rod portion 52. The first rod portion 51 has a cylindrical outer shape. The first rod portion 51 is located higher than the second rod portion 52 and is coupled to the base 20. The second rod portion 52 extends downward from a bottom end of the first rod portion 51. A main portion of the second rod portion 52 has an outer shape formed by joining two different half-cylinders together with their rectangular surfaces facing each other.

More specifically, the bottom end of the first rod portion 51 is inserted to the second rod portion 52 from a top end of the second rod portion 52. In a portion where the first rod portion 51 and the second rod portion 52 overlap, a through hole 53a that penetrates the first rod portion 51 and the second rod portion 52 is provided in a direction orthogonal to the up-down direction. A first pin 53b is inserted to the through hole 53a, thereby fixing the first rod portion 51 and the second rod portion 52.

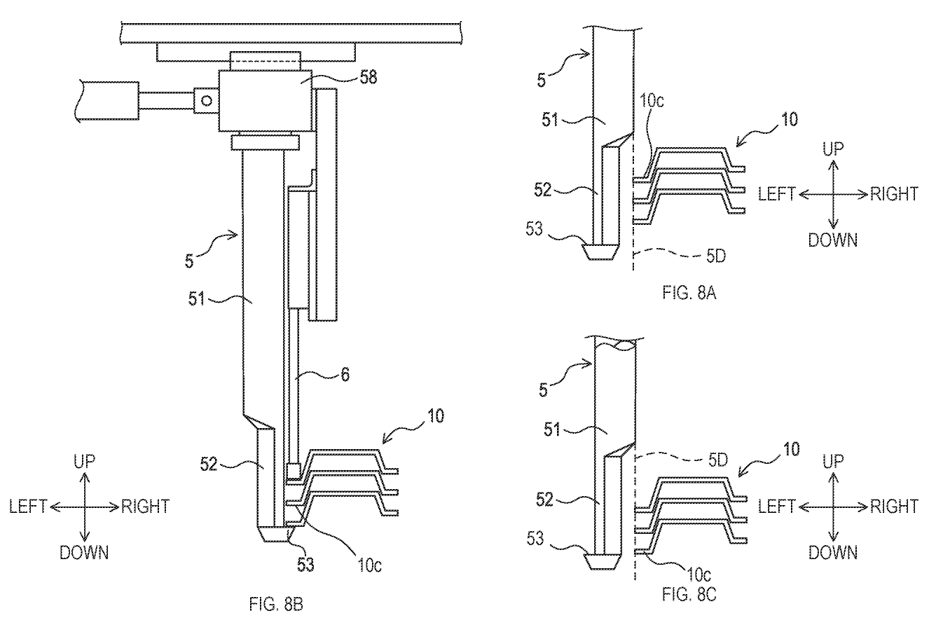

The rod portion 5 has a rotation axis 5A extending along the up-down direction. More specifically, the rotation axis 5A penetrates the center of a circle in a cross section orthogonal to the up-down direction of the first rod portion 51. The rod portion 5 is rotatable about the rotation axis 5A. More specifically, the rod portion 5 is configured to be rotatable by the first driving portion 58 shown in FIG. 8B. The first driving portion 58 is, for example, a rotary actuator.

The rod portion 5 has a projection 53. The projection 53 protrudes from a portion of a side surface of the rod portion 5 and is configured to come into contact with a bottom surface of the object 10. More specifically, if the side surface of rod portion 5 is divided into a first side surface 54a with the projection 53 and a second side surface 54b without the projection 53 by a virtual plane 5B having a surface extending in the up-down direction (in other words, vertical direction), then the projection 53 is formed to protrude from the first side surface 54a in a direction away from the rotation axis 5A. On the other hand, the projection 53 does not protrude from the second side surface 54b.

In the present embodiment, the virtual plane 5B is a plane passing through the rotation axis 5A. In FIGS. 7A and 7B, the side surface of the rod portion 5 to the right of the virtual plane 5B corresponds to the first side surface 54a, and the side surface to the left of the virtual plane 5B corresponds to the second side surface 54b.

The projection 53 is provided at a bottom end of the rod portion 5. In other words, the projection 53 is provided at a bottom end of the second rod portion 52. The projection 53 protrudes from the first side surface 54a to have a horizontally extending plane. That is, the projection 53 protrudes so that the object 10 can be placed on a top surface of the projection 53. The projection 53 has a crescent shape in plan view. The projection 53 may be formed by fitting another member having the projection 53 to the bottom end of the second rod portion 52. The other member having the projection 53 may be fixed to the second rod portion 52 by a second pin 53c.

In a cross section of the rod portion 5 orthogonal to the rotation axis 5A at a position where the projection 53 is formed, a distance W4 from the rotation axis 5A to a most protruding portion of the projection 53 is designed to be greater than a distance W2 from the rotation axis 5A to the second side surface 54b. Also, a maximum distance W1 from the rotation axis 5A to the first side surface 54a is designed to be greater than a maximum distance W2 from the rotation axis 5A to the second side surface 54b. A maximum distance W5 from the rotation axis 5A to the second side surface 54b in the first rod portion 51 is also equal to the distance W1. Thus, the distance W5 is designed to be greater than the distance W2.

A direction from a side surface of the first rod portion 51 toward a central axis is defined as an inner side. When the first rod portion 51 and the second rod portion 52 are divided into two by the virtual plane 5B, the second side surface 54b in the second rod portion 52 is formed on the inner side compared to the second side surface 54b in the first rod portion 51. The first side surface 54a in the second rod portion 52 and the second side surface 54b in the second rod portion 52 have approximately the same curvature radius. The first side surface 54a in the first rod portion 51 and the first side surface 54a in the second rod portion 52 are flush each other. That is, the rod portion 5 has a shape as if a columnar member having a crescent shaped cross section orthogonal to the rotation axis 5A is cut from a lower half of a cylindrical member. In other words, the second side surface 54b in the second rod portion 52 is formed on the inner side compared to the second side surface 54b in the first rod portion 51 by a difference between the distance W5 and the distance W2.

In FIG. 7B, the center of a bottom surface of the second rod portion 52 and the projection 53 is represented as a center point 5C. The center point 5C does not coincide with the rotation axis 5A but is shifted to the right by a distance W3. That is, the center point 5C is located at a position eccentric from a center point of a cross section of the first rod portion 51 (that is, the rotation axis 5A).

### [1-2. Motions of Conveyance Device]

Motions of the conveyance device 1 will be described with reference to FIGS. 8A to 8C. In FIGS. 8A to 8C, three objects 10 are arranged on top of each other. The conveyance device 1 can transition between a clamped state and an unclamped state. The clamped state is a state in which the objects 10 are held by the rod portion 5 and the holding member 6 as shown in FIG. 8B. The unclamped state is a state in which the objects 10 are not held by the rod portion 5 and the holding member 6, as shown in FIGS. 8A and 8C.

First, an operator of the robotic arm sets horizontal positions of the four rod portions 5 in advance in accordance with the shape of the objects 10. More specifically, the operator moves each slider 3d to its preset position in advance. Also, the operator sets the robotic arm in advance such that the robotic arm moves from a current position of the objects 10 to a destination of the objects 10.

When the operator starts the robotic arm, the conveyance device 1 attached to the robotic arm stops above the objects 10 at the current position of the objects 10.

Next, the conveyance device 1 descends so that the four rod portions 5 surround the objects 10. At this point of time, the four rod portions 5 descend with their second side surfaces 54b facing the objects 10. More specifically, each of the four rod portions 5 descends with the second side surface 54b in the second rod portion 52 facing the objects 10. That is, as shown in FIG. 8A, the projection 53 faces away from the objects 10. Ends of the objects 10 are located on a virtual line 5D extending downward of the second side surface 54b in the first rod portion 51. That is, a clearance is formed between the objects 10 and the second rod portion 52. The clearance corresponds to a distance in the right-left direction between the second side surface 54b in the first rod portion 51 and the second side surface 54b in the second rod portion 52. Each of the four rod portions 5 descends until a top surface of the projection 53 is positioned below a bottom surface of the lowermost object 10. The holding member 6 is set so that the bottom end of the holding member 6 is at the second position.

Next, each of the four rod portions 5 rotates 180 degrees so that the first side surface 54a faces the objects 10. When each rod portion 5 rotates, the first side surface 54a in the second rod portion 52 comes into contact with the object 10.

Next, the conveyance device 1 ascends so that the top surface of the projection 53 comes into contact with the bottom surface of the lowermost object 10. In the present embodiment, the conveyance device 1 ascends so that the top surface of the projection 53 comes into contact with a bottom surface of the flange portion 10c of the lowermost object 10.

Next, the conveyance device 1 moves the bottom end of the holding member 6 to the first position. More specifically, the conveyance device 1 moves the bottom end of the holding member 6 so that the bottom end of the holding member 6 comes into contact with a top surface of the uppermost object 10. In the present embodiment, the conveyance device 1 moves the bottom end of the holding member 6 so that the bottom end of the holding member 6 comes into contact with a top surface of the flange portion 10c of the uppermost object 10. As shown in FIG. 8B, this brings the conveyance device 1 to the clamped state, and the flange portions 10c of the objects 10 are held between the projection 53 and the holding member 6. The conveyance device 1 may move the bottom ends of some of the holding members 6 to the first position. The bottom ends of which holding members 6 are moved to the first position may be set in advance by the operator. The operator may perform the setting in accordance with the shape of the objects 10.

Next, the conveyance device 1 ascends, translates, and moves to the destination of the objects 10 while holding the objects 10.

When the conveyance device 1 reaches the destination of the objects 10, the conveyance device 1 descends while holding the objects 10. Then, each of the holding members 6 moves so that the bottom end of the holding member 6 comes to the second position. Also, each of the four rod portions 5 rotates 180 degrees so that the second side surface 54b faces the objects 10. That is, as shown in FIG. 8C, the projection 53 transitions to a state in which the projection 53 faces away from the objects 10. In other words, the conveyance device 1 transitions to the unclamped state. The ends of the objects 10 are located on the virtual line 5D extending downward of the second side surface 54b in the first rod portion 51. That is, a clearance is formed between the objects 10 and the second rod portion 52. The clearance corresponds to a distance in the right-left direction between the second side surface 54b in the first rod portion 51 and the second side surface 54b in the second rod portion 52. The objects 10 fall to the destination due to gravity.

Next, the conveyance device 1 ascends and moves to a location where another objects 10 are in order to convey those objects 10.

### [1-3. Effect]

According to the embodiment detailed above, the following effects can be obtained.

(1a) Each rod portion 5 is rotatable about the rotation axis 5A and has the projection 53. The projection 53 protrudes from the first side surface 54a in a direction away from the rotation axis 5A and does not protrude from the second side surface 54b.

If the rod portion 5 is not rotatable, it is necessary, in order lift the objects 10, to translate the rod portion 5, in a state in which the projection 53 faces the object 10, from the position away from the objects 10 to a position where the rod portion 5 comes into contact with the objects 10. In order to lower the objects 10 at the destination, it is necessary to translate the rod portion 5 from the position in contact with the objects 10 to a position away from the objects 10. In other words, when the motion to lift the objects 10 and the motion to lower the lifted objects 10 at the destination are performed, it is necessary to translate the rod portion 5 at least by a protruding amount of the projection 53.

However, according to the above-described configuration, it is only necessary to rotate by 180 degrees the rod portion 5 in a state in which the projection 53 faces away from the objects 10, in order to lift the objects 10. Thus, it is not necessary to translate the rod portion 5. Also, in order to lower the lifted objects 10 at the destination, it is only necessary to rotate the rod portion 5 by 180 degrees to transition to the state in which the projection 53 faces away from the objects 10. Thus, it is not necessary to translate the rod portion 5. Therefore, when the motion to lift the objects 10 and the motion to lower the lifted objects 10 at the destination are performed, there is no need for a guide device for translating and positioning the rod portion 5. Thus, with a simple configuration, it is possible to perform the motion to lift the objects 10 and the motion to lower the lifted objects 10 at the destination.

Also, when the motion to lift the objects 10 and the motion to lower the lifted objects 10 at the destination are performed, it is not necessary to translate the rod portion 5 by the protruding amount of the projection 53. Thus, for example, when the objects 10 are horizontally aligned at the location where the objects 10 are, a distance between the adjacent objects 10 can be narrowed. Also, for example, even when the objects 10 are horizontally aligned at the destination of the objects 10, a distance between the adjacent objects 10 can be narrowed. Therefore, compared to a case where the rod portion 5 is not rotatable, a space for placing the objects 10 can be reduced.

Also, since there is no need for a guide device, the conveyance device 1 can be downsized and lightweight.

Further, since a motion to translate the rod portion 5 is not necessary in performing the motion to lift the objects 10 and the motion to lower the lifted objects 10 at the destination, motions to be performed by the conveyance device 1 are reduced. Since cycle time is improved, efficiency of conveying the objects 10 can be increased.

Also, in lowering the lifted objects 10 at the destination, if the conveyance device 1 tilts as the rod portion 5 moves away from the objects 10 as in a case where the rod portion 5 is designed to be non-rotatable, then the objects 10 may fall in a tilted state and may not be lowered at a desired position. However, according to the above-described configuration, although there is a slight clearance between the objects 10 and the second side surface 54b in lowering the lifted objects 10 at the destination, no large gap is formed as would be formed if the rod portion 5 is translated. Therefore, even if the conveyance device 1 tilts, the objects 10 fall while contacting the rod portion 5. Thus, the objects 10 do not tilt significantly, making it easier to lower the objects 10 to a desired position.

(1b) Each holding member 6 has the moving mechanism configured to move the bottom end of the holding member 6 between the first position and the second position. The above configuration allows the objects 10 to be held between the projection 53 and the holding member 6 when the bottom end of the holding member 6 is located at the first position. Thus, it is possible to convey the objects 10 in a stable manner.

(1c) The second side surface 54b in the second rod portion 52 is formed on the inner side compared to the second side surface 54b in the first rod portion 51. With the configuration as above, the side without the projection 53 is recessed on the inner side. Thus, since a clearance is formed between the objects 10 and the second side surface 54b in the second rod portion 52 when the conveyance device 1 transitions from the clamped state to the unclamped state, the objects 10, when falling, are less likely to hit the second side surface 54b in the second rod portion 52. Accordingly, it is easy to lower the objects 10 without damaging the objects 10.

(1d) The curvature radius of the first side surface 54a of the second rod portion 52 and the curvature radius of the second side surface 54b in the second rod portion 52 are approximately the same. With the configuration as above, since the second rod portion 52 does not have corners and protrusions, the rod portion 5 is less likely to hit the objects 10 when it rotates. Thus, the rod portion 5, when it rotates, is less likely to damage the objects 10.

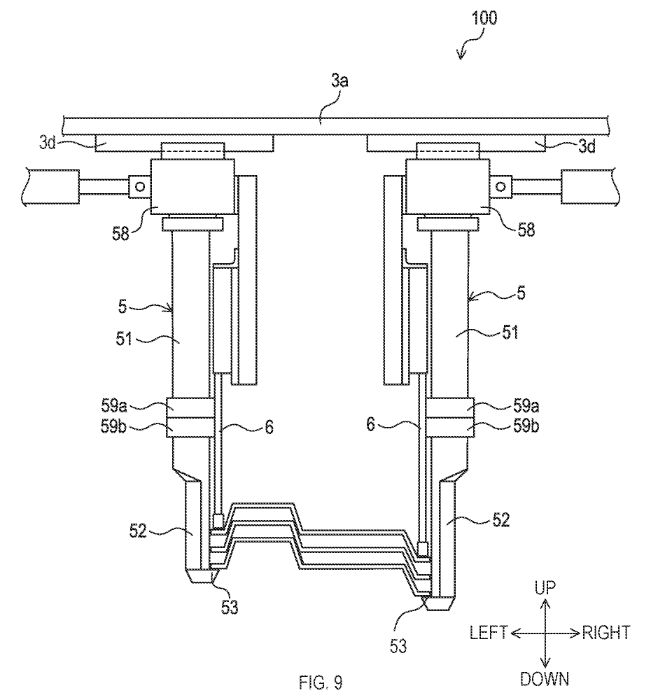

(1e) The bottom end of the first rod portion 51 is inserted to the second rod portion 52 from the top end of the second rod portion 52. The through hole 53a is provided at the portion where the first rod portion 51 and the second rod portion 52 overlap. The first pin 53b is inserted into the through hole 53a, and the first rod portion 51 and the second rod portion 52 are joined. The above configuration allows the second rod portion 52 to be removed by removing the first pin 53b from the through hole 53a. Thus, the second rod portion 52 can be replaced with another second rod portion 52. That is, the rod portion 5 has a replacement mechanism for replacing the second rod portion 52 with another second rod portion 52. For example, by replacing the second rod portion 52 with one having a different length, the height position of the projection 53 can be varied. Thus, as shown in FIG. 9, even with the objects 10 having the bottom surfaces with different height positions, the objects 10 can be placed by adjusting the length of the second rod portion 52.

The replacement mechanism is not limited to the configuration including the through hole 53a and the first pin 53b. For example, as shown in FIG. 9, the replacement mechanism may include a first engagement portion 59a and a second engagement portion 59b. The first engagement portion 59a may have a helical groove inside, and the second engagement portion 59b may have a convex portion that engages with the helical groove. Also, the first engagement portion 59a and the second engagement portion 59b may be configured to engage with each other by snap fit.

(1f) The distance that each rod portion 5 horizontally moves from a specified position can be set for each rod portion 5. The above configuration allows the horizontal position of each rod portion 5 to be set in accordance with the shape of the objects 10. Since the rod portion 5 can be used for the objects 10 having various shapes, versatility of the conveyance device 1 can be increased.

### [1-4. Correspondence Relationship]

In the above-described embodiment, the first rod portion 51 corresponds to the upper rod portion, and the second rod portion 52 corresponds to the lower rod portion.

### [2. Other Embodiments]

The embodiments of the present disclosure have been described in the above. The present disclosure is not limited to the above-described embodiments and can be practiced in various forms.

(2a) The above-described embodiment describes the conveyance device 1 comprising the four rod portions 5, as an example. However, the number of the rod portions 5 is not limited to this. For example, the conveyance device 1 may comprise three rod portions 5, or five or more rod portions 5.

(2b) The above-described embodiment describes the conveyance device 1 comprising the rod portions 5 each including the replacement mechanism for replacing the second rod portion 52 with another second rod portion 5. However, as shown in FIG. 6, the rod portion 5 may have a telescoping mechanism 56 configured to switch a length of the rod portion 5 between a first length and a second length longer than the first length. More specifically, the length of the rod portion 5 may be switched using the telescoping mechanism 56 with a built-in servomotor. For example, the first rod portion 51 and the second rod portion 52 may be formed into pipes having different diameters. A lower portion of the first rod portion 51 and an upper portion of the second rod portion 52 may be arranged to overlap each other, and changing a length of the overlapped portion may cause expansion and contraction. In other words, by changing the length of the overlapped portion, the length of the rod portion 5 may be changed. The above configuration allows the height position of the projection 53 to be varied for each rod portion 5. Thus, even with the objects 10 with different bottom surface height positions, the objects 10 can be placed on the projection 53 by adjusting the length of the rod portion 5.

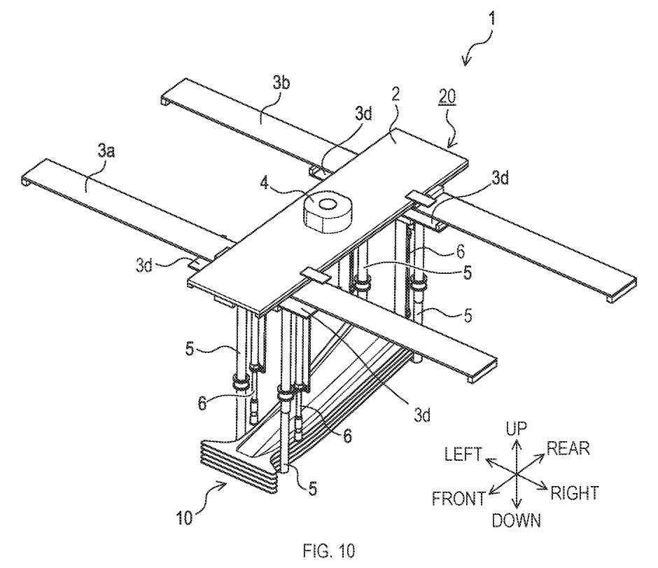

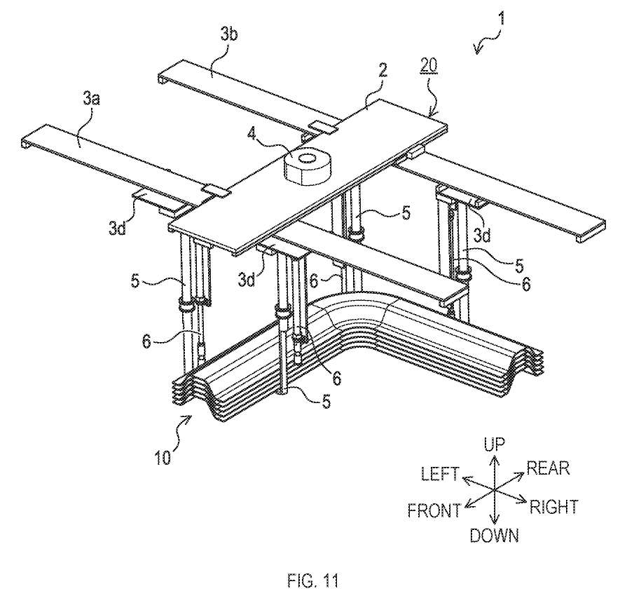

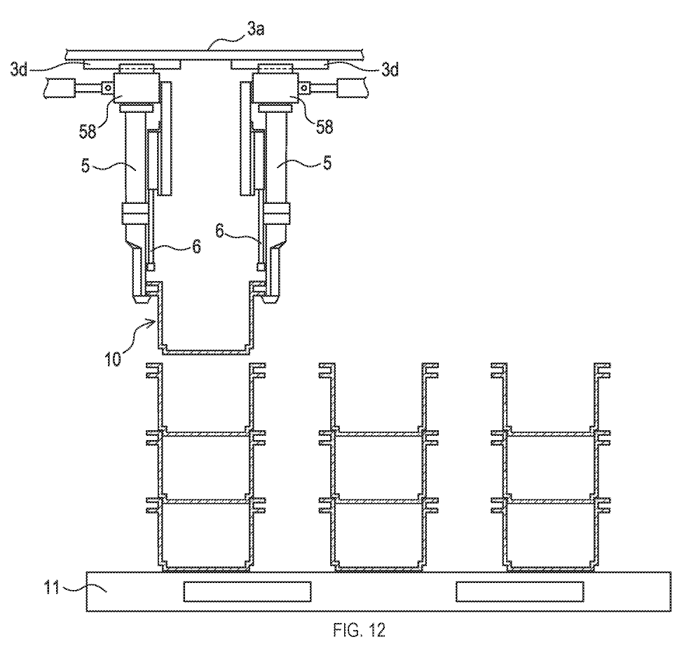

(2c) In the above-described embodiment, an example of the object 10 is a center-pillar. However, types of the objects 10 are not limited to this. For example, as shown in Variation 1 in FIG. 10, the object 10 may be a floor cross bar. Also, for example, as shown in Variation 2 in FIG. 11, the object 10 may be a back door opening hinge. Also, for example, as shown in Variation 3 in FIG. 12, the object 10 may be a resin case. The conveyance device 1 can palletize or depalletize the cases onto a pallet 11. Also, the object 10 may be box-shaped without the flange portion 10c. For example, the conveyance device 1 can also convey blocks and bricks.

(2d) The above-described embodiment describes the conveyance device 1 in which the attachment part 4 is attached to the robotic arm. However, a device to which the base 20 is attached is not limited to the robotic arm. The base 20 only needs to be attached to the moving device configured to move the conveyance device 1 from the location where the objects 10 are to the destination of the objects 10. For example, the base 20 may be attached to a moving device configured to slide the conveyance device 1.

(2e) In the above-described embodiment, the second side surface 54b in the second rod portion 52 is formed on the inner side compared to the second side surface 54b in the first rod portion 51, as an example. However, the shape of rod portion 5 is not limited to this. For example, the second rod portion 52 may also have the same cylindrical shape as the first rod portion 51.

(2f) In the above-described embodiment, the virtual plane 5B is a plane that passes through the rotation axis 5A. However, the virtual plane 5B may be a plane that does not pass through the rotation axis 5A. The virtual plane 5B only needs to divide the first rod portion 51 and the second rod portion 52 into two.

(2g) Two or more functions achieved by one element of the above-described embodiment may be achieved by two or more elements. One function achieved by one element may be achieved by two or more elements. Two or more functions achieved by two or more elements may be achieved by one element. One function achieved by two or more elements may be achieved by one element. A part of the configurations in the above-described embodiment may be omitted. At least a part of the configurations in the above-described embodiment may be added to or replaced with another part of the configurations in the above-described embodiment.

What is claimed is:

1. A conveyance device configured to lift and move at least one object, the conveyance device comprising:
a base; and
at least three rod portions,
wherein the base holds the at least three rod portions at a specified horizontal width and is attachable to a moving device configured to move the conveyance device from a location where the at least one object is to a location where the at least one object is to be conveyed,
wherein each of the at least three rod portions is attached to the base and extends downward of the base,
wherein each of the at least three rod portions is rotatable about a rotation axis extending along an up-down direction and has a projection,
wherein the projection protrudes from a portion of a side surface of each of the at least three rod portions and is designed to come into contact with a bottom surface of the at least one object,
wherein, when the side surface of each of the at least three rod portions is divided into a first side surface with the projection and a second side surface without the projection by a virtual plane having a vertically extending surface, the projection protrudes from the first side surface in a direction away from the rotation axis, and does not protrude from a second side surface, and
wherein a distance from the rotation axis to a most protruding portion of the projection, in a cross section of each of the at least three rod portions orthogonal to the rotation axis at a position where the projection is formed, is greater than a distance from the rotation axis to the second side surface.

2. The conveyance device according to claim 1, further comprising:
a holding member,
wherein the holding member is a rod-shaped member extending downward of the base, and
wherein the holding member includes a moving mechanism configured to move to a first position that is a height position where a bottom end of the holding member comes into contact with a top surface of the at least one object and a second position higher than the top surface of the at least one object.

3. The conveyance device according to claim 1,
wherein each of the at least three rod portions has a first rod portion coupled to the base and a second rod portion extending downward from a bottom end of the first rod portion,
wherein the second rod portion has the projection,
wherein, when a direction from a side surface of the first rod portion toward the rotation axis is defined as inner side, and the first rod portion and the second rod portion are divided into two by a virtual plane, a maximum distance from the rotation axis to the first side surface, in a cross section of the second rod portion orthogonal to the rotation axis at a position where the projection is formed, is greater than a distance from the rotation axis to the second side surface, and
wherein the second side surface in the second rod portion is formed on the inner side compared to the second side surface in the first rod portion.

4. The conveyance device according to claim 3,
wherein the first side surface in the second rod portion and the second side surface in the second rod portion have approximately same curvature radius.

5. The conveyance device according to claim 1,
wherein at least one rod portion of the at least three rod portions includes a telescoping mechanism configured to switch a length of the at least one rod portion between a first length and a second length longer than the first length.

6. The conveyance device according to claim 1,
wherein at least one rod portion of the at least three rod portions has an upper rod portion coupled to the base and a lower rod portion extending downward from a bottom end of the upper rod portion,
wherein the lower rod portion has the projection, and
wherein the at least one rod portion includes a replacement mechanism configured to replace the lower rod portion with another lower rod portion.

7. The conveyance device according to claim 1,
wherein the at least three rod portions are horizontally movable, and
wherein a distance that each of the at least three rod portions horizontally moves from a specified position is settable for each of the at least three rod portions.
